(19) United States
(12) Patent Application Publication
(10) Pub. No.: US 2009/0106540 A1
(43) Pub. Date: Apr. 23, 2009

(54) APPARATUS AND METHOD FOR REMANIPULATING INSTRUCTIONS

(75) Inventor: Josef Haid, Graz (AT)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 11/874,326

(22) Filed: Oct. 18, 2007

(51) Int. Cl. G06F 9/318

(52) U.S. Cl. 712/238; 712/E09.035

(57) ABSTRACT

An apparatus for modifying instructions of a machine readable program according to remanipulation rules includes a remanipulation unit, which is configured to identify a manipulated instruction and to remanipulate the manipulated instruction according the remanipulation rules. The apparatus further includes a processor unit configured to process a predetermined instruction set, wherein the predetermined instruction set includes manipulated instructions and remanipulated instructions.

### BACKGROUND OF THE INVENTION

The present invention relates to an apparatus and to a method to remanipulate instructions to be processed in a processor and especially to a manipulation of a digital stream of instructions.

In modern communication technology, it has become increasingly important to provide a high measure of security for sensible data. Since most of the data nowadays is processed by computers, or by processors, it becomes increasingly important to protect the data handling of the computer. This includes especially a protection with respect to the processing of data or of instructions, which are processed by the Central Processing Unit (CPU). Unauthorized persons should not get access to the data or should be unable to understand the way how the data is processed by the processor. Applications such as pay-TV or other applications whose content should be made accessible only to a limited number of authorized customers rely on an efficient way to cover the manner in which the processor is handling data. This is basically no problem for proprietary processor systems, which are however costly. The pressure for cost efficiency is putting at the same time constraints on the hardware to be used in communication devices. The aim is to use as much standard components as possible, which are widely available at an affordable cost. These standard components are, however, an easy target for an attack, for example, to uncover the data handling. Therefore, there is a need to cover, as efficiently as possible, the data handling of standard components like standard processors or standard CPUs.

### BRIEF SUMMARY OF THE INVENTION

Embodiments of the present invention relate to an apparatus for modifying instructions of a machine readable program according to remanipulation rules. The apparatus includes a remanipulation unit, which is configured to identify a manipulated instruction and to remanipulate the manipulated instruction according the remanipulation rules. The apparatus further comprises a processor unit configured to process a predetermined instruction set, wherein the predetermined instruction set includes manipulated instructions and remanipulated instructions.

### BRIEF DESCRIPTION OF SEVERAL VIEWS OF THE DRAWINGS

The features of the embodiments of the invention will be more readily appreciated and better understood by reference to the following detailed description, which should be considered with reference to the accompanying drawings, in which:

FIG. 1 shows a schematic view of an embodiment of the present invention;

FIG. 2 shows a schematic view of a remanipulation unit;

FIG. 3 shows a schematic view of a processor unit;

FIG. 4 illustrates a stream of instructions comprising a manipulated instruction;

FIG. 5 shows table comprising a possible mapping between instruction and manipulated instructions;

FIG. 6 shows a structure of an instruction; and

FIG. 7 illustrates a block diagram of a manipulation unit.

Before embodiments of the present invention are explained in more detail below with reference to the drawings, it is to be noted that equal elements, or those operating in an equal manner are provided with same or similar reference numerals in the figures, and that a repeated description of these elements is omitted.

### DETAILED DESCRIPTION OF THE INVENTION

A processor to be used in a computer, for example, can handle a number of processor-specific instructions (instruction set) and a (computer) program comprises in general a stream of instructions to be processed by the processor. Hence, the set of instructions comprising the program should be processor compatible in order to be processed by the processor. In case the program as a sequence of instructions is known for a given type of processor, the program can be executed on any other instruction compatible processor. It is, moreover, possible to uncover and obtain the functionality of the program and to realize it on another processor.

In order to avoid this for critical applications, as for example for pay-TV cards, usually processors are used, that support only a fixed set of instructions, which are moreover not supported by so-called off-the-shelf processors.

This offers the following advantages:

(a) a potential attack could only be made possible by a significant effort to obtain the instructions of the program from the byte stream (digital data stream) and thereby understand the meaning and/or functioning of the program. This task is made more difficult, for example, by the fact that the data book is usually distributed only under a non-disclosure agreement;
b) the simple copying and executing of the program on a computer using a standard processor is made impossible by this.

The embodiments of the present invention relate to the possibility that the instruction set in the byte stream of the program can be manipulated and remanipulation directly before it is input into the processor or the central processor unit (CPU). The manipulated instruction set makes it difficult to understand program code and to remake the program. The manipulation rules used to manipulate instructions in the first place and to remanipulate the instruction, directly before inputting them into the CPU can theoretically, be made as complex as possible, so that it becomes in practice impossible to uncover the instructions set during a possible attack. Hence, the complete functionality of the program can only be understood in connection with the knowledge of the manipulation rules.

Embodiments of the present invention comprise an apparatus to modify instructions of a machine readable program according to a remanipulation rule, the apparatus comprising a remanipulation unit and a processor unit. The remanipulation unit is configured to identify a manipulated instruction within the instruction set, and moreover, to remanipulate the manipulated instruction according to the remanipulation rules. The processor unit processes a predetermined instruction set comprising the manipulated instructions, as well as the remanipulated instructions. Therefore, the manipulation of the instructions do not change the instructions itself, but change or modify the meaning of a given instruction according to the manipulation rules (adding instead of subtracting certain register content, for example).

Further embodiments comprise also an apparatus to manipulate the instruction set according to a manipulation rule. The apparatus comprises a manipulation unit configured to manipulate instructions and to output the manipulated instructions. The apparatus to manipulate instructions can, for example, be part of a compiler used to generate the byte stream from a program source code.

According to embodiments, the instructions of a program are manipulated or remanipulated, before they are input into the processor unit. The manner of manipulation can be quite flexible and are determined by the programmer. In the following, three examples are explained in more detail.

### EXAMPLE 1

Modifying the meaning. The simplest way to manipulate an instruction set is to change the meaning of a given instruction. For example, instruction 1 can be given the meaning of instruction 2 and vice-versa. By this, the whole set of instructions can be mapped on another set of instructions in the manner that each instruction is mapped onto a new instruction having a different meaning. A simple example is given by changing operation codes (op-codes) which refer to an addition or subtraction of register entries:

### ADD Rx, Rx=>SUB Rx, RX

### SUB Rx, Rx=>SUB Rx, RX

This mapping can comprise all instruction or only part of them, e.g. instruction, which are typically used regularly. The remaining instruction can be left unmodified.

### EXAMPLE 2

Mapping more than one op-code onto a single instruction. This means that for example an instruction 1 and an instruction 2 are both mapped onto an instruction 3 or a plurality of instructions are mapped onto a single instruction. For example, two different operations can be mapped on NOPs (NOP=No Operation):

### 0×A577=>NOP

### 0×B734=>NOP

By mapping two instructions onto one instruction, the instruction set, effectively looses one instruction and hence is not a uniquely reversible process. This, however, can be tolerated as many programs use only a reduced set of instructions and the unused instructions can be used for the manipulation purposes. For example, in the manipulation process the instruction 3 is randomly mapped onto the instruction 1 and instruction 2 and both are mapped back to instruction 3 in the remanipulation process.

### EXAMPLE 3

A further example is not to map a given instruction onto a new instruction but instead to map a sequence of instructions onto a new instruction or onto a new sequence of instructions. For example, an instruction 1 followed by an instruction 2 can be mapped onto an instruction 3 followed by an instruction 4. Another example would be that the instruction 1 followed by the instruction 2 can be mapped onto an instruction 4. Also here, a whole plurality of subsequent instructions can be mapped onto another plurality of subsequent instructions, but only one plurality of subsequent instructions can be executed by the processor in a sensible way.

For example, a mapping of a sequence of op-codes onto another sequence of op-codes comprises:

### ADD Rx, Rx+SUB Rx, Rx=>NOP+NOP

and therefore, an instruction of an adding followed by a subtracting is remanipulated into two NOP instructions.

Thus, embodiments of the present invention relate also to a method for (re)manipulating the instruction-byte-stream before it is input into the instruction decoder of a CPU. The manipulation rules can be made as flexible or as involved as possible and can even change during operation. This means that the instructions are not always (re)manipulated in the same way—the instruction rules, can for example, be time dependent (depending for example on the current day) or depend on the occurrence within the program or within a subroutine of the program.

The manipulation rules can, for example, be input into the remanipulation unit by a separate input and hence, can be stored separately from the program code, which makes the system much more secure, since for a potential attacker it is difficult to understand the meaning of the program code and to reengineer a program.

Embodiments of the present invention comprise numerous advantages over conventional methods. For example, in case it would be possible to read the program, it is nevertheless very difficult to obtain the meaning of functionality of the program, since the manipulation rules are still needed for this. It is also advantageous that standard processor, as for example, ARM processors (ARM=Acorn Risc Machine) can be used without risking a successful attack. Without instruction manipulation, this would be impossible, as it would be simple to uncover the program structure and the instruction stream. It is moreover of advantage, that the manipulation or the remanipulation can optionally be done on-the-fly. This means that one and the same code piece could comprise two meanings, for example, to add or to subtract data. An example of this is given by the manipulation rule, where the meaning of the manipulated instruction depends on the previous instruction or on a sequence of previous instructions.

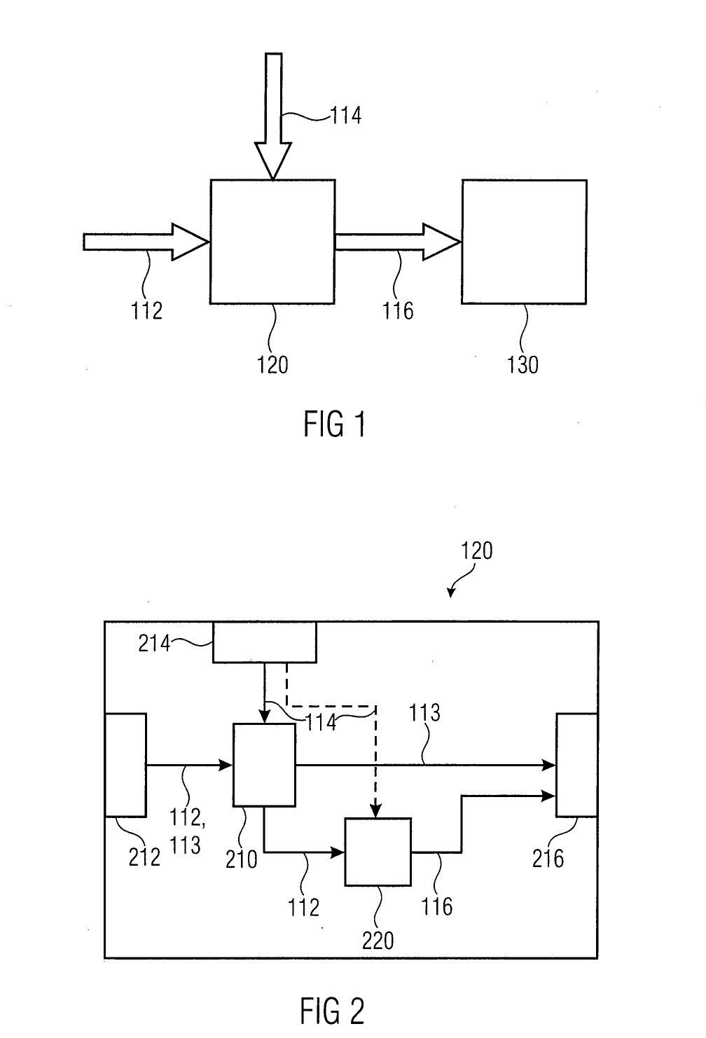

FIG. 1 shows a block diagram of an embodiment of the present invention. Manipulated instructions 112 and a remanipulation rule 114 is input into a remanipulation unit 120, wherein the remanipulation rule 114 can comprise one or a plurality of rules. In the former case, only one instruction is manipulated whereas in the latter case a plurality of instructions have been modified or manipulated. The remanipulation unit 120 uses the remanipulation rules 114 to identify and to remanipulate the manipulated instruction 112 and output a remanipulated instruction 116 that is turn input into a processor unit 130.

Hence, the byte stream of instructions is input into the remanipulation unit 120 and after identifying and remanipulating the manipulated instruction 112 the set of instructions, is sent to the processor unit 130. The remanipulation rules 114 can be input separately in order to support a preferred embodiment, wherein the remanipulation rules 114 and the program code are stored separately. This makes it more difficult to understand and comprehend the meaning of the program code.

FIG. 2 shows a schematic block diagram of the remanipulation unit 120 comprising an input device 212 for the manipulated instruction 112, an additional input device 214 for the remanipulation rules 114 and an output interface 216 for the remanipulated instruction 116. The remanipulation unit 120 comprises moreover a detector 210 with an input for the remanipulation rules 114. The detector 210 analyzes the stream of instructions, which are input through the input device 212 and detects the manipulated instruction 112 and sends the manipulated instruction 112 to a remanipulator 220. The remanipulator 220 remanipulates the manipulated instruction 112 according to the remanipulation rules 114 and sends the remanipulated instruction 116 to the output interface 216. If the detector 210 does detect an unmodified instruction 113 (an instruction, which has not been manipulated), it sends the unmodified instruction 113 directly to the output interface 216. The remanipulator 220 can obtain the remanipulation rules 114 either from the detector 210 (for example during a start up period) or, optionally, obtains the remanipulation rules 114 directly from the additional input device 214.

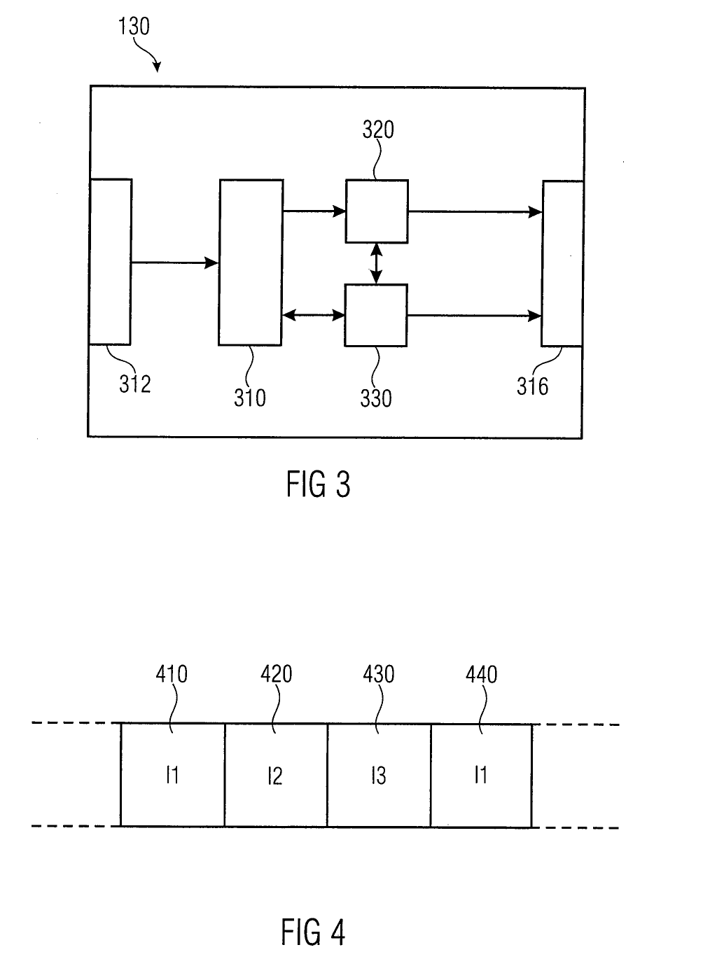

FIG. 3 shows a schematic block diagram of the processor unit 130. The processor unit 130 comprises, for example, an input interface 312 and an output interface 316, an instruction decoder 310, an arithmetic logic unit 320 (ALU=Arithmetic Logic Unit) and a register 330. The stream of instructions, which comprises, for example, an unmodified instruction 113 and the remanipulated instruction 116, is input in the input interface 312 and is sent to the instruction decoder 310 that analyzes the stream of instructions. The instructions are either executed directly by using a connection to the register 330 or are sent to the ALU 320 so that the ALU executes the instruction. After the instruction has been executed, the result is sent to the output interface 316. During the step of execution various portions of the processor unit 130 can be interconnected so that it can perform the desired operation (instruction). If, for example, an additional operation is requested, the ALU will be connected to a set of inputs and a set of outputs (e.g. certain register entries). The inputs provide the number to be added, for example, and the outputs will contain the final sum. The ALU comprises appropriate circuitry to provide simple arithmetic and logic operations (like addition and byte-wise operations).

FIG. 4 shows a schematic view on the stream of instructions comprising a first instruction 410, a second instruction 420, a third instruction 430 and a fourth instruction 440. In this embodiment, the first instruction 410 and the fourth instruction 440 comprise the instruction I1, the second instruction 420 comprises the manipulated instruction I2 (112) and the third instruction 430 comprises the instruction I3.

In this embodiment, the first, third and fourth instruction 410, 430, 440 comprise unmodified instructions 113 and hence, the detector 210 in the remanipulation unit 120 sends these instructions directly to the output interface 216, whereas the second instruction 420 will be identified by the detector 210 as a manipulated instruction 112 and send to the remanipulator 220 in order to be remanipulated, and subsequently sent to the output interface 216. In order to identify a manipulated instruction 112, the detector 210 reads the remanipulation rules 114, which identify the instructions which have been manipulated.

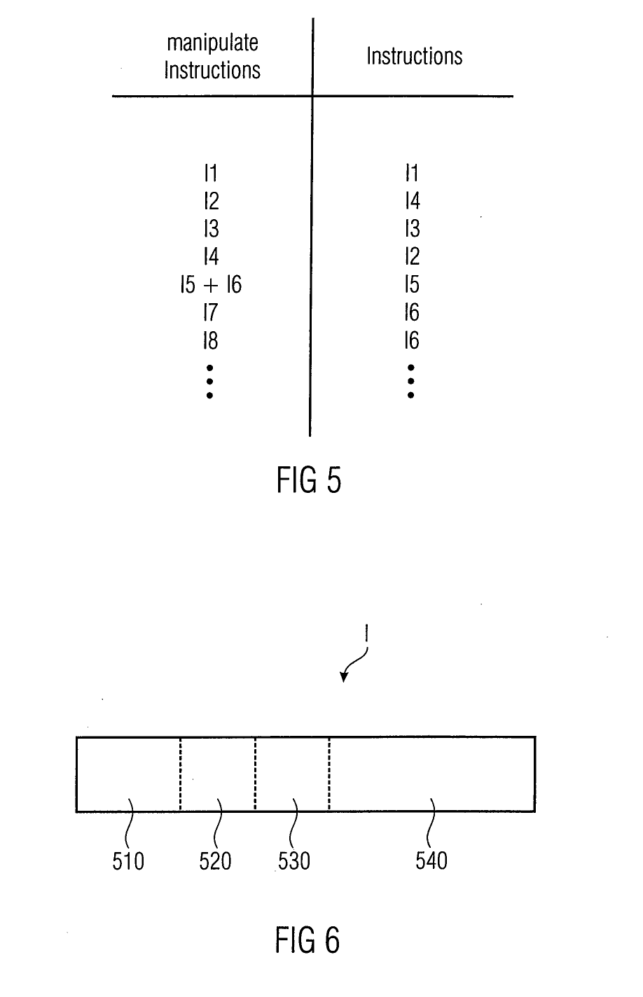

FIG. 5 shows a simple embodiment for the remanipulation rules 114 in form of a table. Hence, the table comprises a mapping between instructions and manipulated instructions, wherein a total set of instructions In (n=1, 2, 3, . . . ) comprise all processor compatible instructions. The first row comprises the manipulated instructions, for example, a first instruction I1, a second instruction I2, a third instruction I3 and so on. The second row comprises remanipulated instructions starting with a first instruction I1 followed by a fourth instruction I4, a third instruction I3 and so on. The manipulation rules 114 for this embodiment map the first instruction I1 to itself, the second instruction I2 onto the fourth instruction I4, the third instruction I3 onto itself and the fourth instruction I4 onto the second instruction I2. The sequence of the fifth instruction followed by the sixth instruction (I5+I6) is mapped onto the fifth instruction I5, the seventh instruction is mapped onto the sixth instruction, and the eighth instruction is also mapped onto the sixth instruction. This table can be continued until all available instructions are codified.

In the process of manipulating original instructions to obtain the manipulated instructions 112, the sixth instruction I6 was mapped onto the seventh instruction I7 and also onto the eighth instruction I8. Since both instructions are remanipulated by the remanipulation unit 120 to the same instruction I6, the manipulation unit can map the instruction I6, for example, randomly (or using a certain system) to the instructions I7 and I8. Since after remanipulation the instructions I7 and I8 are absent in the stream of instructions, this is only consistent if, for example, the program does not need the instructions I7 or I8. Otherwise, the mapping or remapping would be inconsistent. Typically, this does not represent a problem, since most programs use anyway only a restricted set of instructions.

Hence, embodiments change only the mapping of given instructions to certain operations, but leave the instruction set of a given processor unit 130 unchanged—the instructions set of the processor unit 130 is neither configured nor changed. This is especially important in order to use standard CPUs and to put all the manipulation or remanipulation into a manipulation unit 120′ or remanipulation unit 120.

FIG. 6 shows a typical instruction I comprising a certain number of bits (for example 16 or 32 in total), which are typically organized in groups. For example, the instruction I comprises a first group 510 with the operation code, a second group 520 comprising for example register address, a third group 530 comprising a second register address and finally a fourth group 540 comprising, for example, an immediate value. The first group 510 can comprise for example 6 bits, the second and third groups 520 and 530 can each comprise for example 5 bits and the fourth group 540 can comprise for example 16 bits, so that in total 32 bits are addressed by this structure of the instruction I. This example demonstrates how a 32 bit instruction word can be decoded, wherein the addresses of the second and third groups 520 and 530 specify for example general purpose registers. In this example, the operation code (first group 510) specifies the operation to be performed and is specified, for example, by a binary number. An example comprises the subtracting or adding. The fourth group 540 identifies the number to be added to the value stored at the second address (specified by the third group 530) and the result is to be stored in the register specified by the second group 520.

The remanipulation rules 114 only need to change the operation code (in the first group 510) so that the operation done by this instruction is changed. The remaining values in the second, third and fourth group 520, 530, 540 of the instruction I can remain unchanged. The operation code is typically encoded by a binary number, so that in the process of remanipulation one binary number is changed into another binary number. Thus, embodiments change only the operation code, but not the whole instruction, that means the second, third and fourth group 520, 530, 540 in the instruction I are not changed. Manipulating instructions refers therefore to a manipulation of the operation to be performed and does not refer to changes in the arguments (or objects) of the operation.

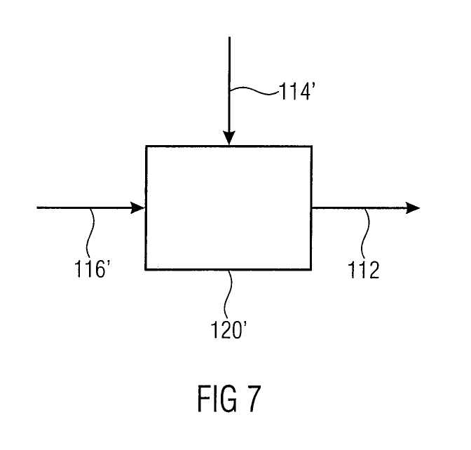

FIG. 7 shows an embodiment for a manipulation unit 120′ comprising an input interface for original instructions 116′ and an input for manipulation rules 114′. The manipulation unit 120′ generates from the stream of original instructions 116′, a stream of manipulated instructions 112 by using the manipulation rules 114′, which are inverted by the remanipulation rules 114. The manipulation unit 120′ can use for the manipulation a table as the one given, for example, in FIG. 5.

The manipulation unit 120′ can for example be combined with a compiler, which is used for compiling the program from the source code into a stream of executable instructions. Further embodiments use a different compiler for compiling the program, so that from the source code, a different or manipulated machine code is generated and the remanipulation unit identifies the “errors” and modifies the instruction code in a manner that it becomes executable in a sensible way by the CPU (processor unit 130).

The instructions 116′ and 116 are real instructions to be processed by the processor unit 130 in a sensible way (so that the program fulfills its purpose). The stream of instructions 112 comprise a byte stream comprising at least a part of manipulated instructions. The stream of instructions 112 comprise also valid instructions and therefore it can be executed by the processor unit 130—but the program will crash or generate meaningless output.

The (re)manipulation rules 114′, 114 can also be changed dynamically so that it becomes impossible to conclude from manipulation rules 114′ valid for a given time period to manipulation rules valid in the future. This makes it more difficult for a potential attacker to understand and to retrieve the functionality of the program.

The main advantage of embodiments is that standard CPUs can be used and only needs to be connected with a one dimensional matcher (remanipulation unit 120) which for example, just interchanges the op-codes adding to subtracting or moving one storage cell to moving a different storage cell. The (re)manipulation rules 114, 114′ can, for example, be stored on a separate chip, which is difficult to read out and, hence, improves even further the security. The dynamic change of the (re)manipulation rules 114, 114′ can for example also comprise the possibility that for different program parts, different manipulation rules are used. The different program parts can for example comprise different sub-routines, multi-stages algorithms (AIS) and for each of them, a different manipulation or remanipulation rules can be used.

This can, moreover, be combined with a change in the manipulation rules during the operation time. The illustrated examples for manipulating instructions (see table in FIG. 5) are only very simple—there are also more complex examples possible. For example, the op-code for adding can for example be encoded in a manner that it comprises a whole series of operation to be done by the CPU (including for example certain sub-routines which have to be carried out). In contrast to the CPUs that can be reconfigured, embodiments of the present invention change the instruction set within a byte stream of instructions following manipulation rules 114′, which are imposed from outside (e.g. by a programmer) and are not adapted to optimize a certain application to be executed by a CPU. Therefore, embodiments map the set of instructions of the given CPU onto itself, while changing the meaning of a given instruction or a sequence of instructions. Therefore, the manipulated instructions are still valid instructions to be understood by the processor unit 130, however, the byte stream of manipulated instructions 112 will not be executed in the designated way for the program.

Depending on certain implementation requirements of the inventive methods, the inventive methods can be implemented in hardware or in software. The implementation can be performed using a digital storage medium, in particular a disk or a CD having electronically readable control signals stored thereon, which cooperate with a programmable computer system such that the inventive methods are performed. Generally, the present invention is, therefore, a computer program product with a program code stored on a machine readable carrier, the program code being operative for performing the inventive methods when the computer program product runs on a computer. In other words, the inventive methods are, therefore, a computer program having a program code for performing at least one of the inventive methods when the computer program runs on a computer.

What is claimed is:

1. An apparatus for modifying instructions of a machine readable program according to remanipulation rules, comprising:
a remanipulation unit configured to identify a manipulated instruction and to remanipulate the manipulated instruction according to the remanipulation rules; and
a processor unit configured to process a predetermined instruction set,
wherein the predetermined instruction set comprises manipulated instructions and remanipulated instructions.

2. The apparatus of claim 1, wherein the remanipulation rules comprise a mapping table assigning a manipulated instruction to a remanipulated instruction, and wherein the remanipulation unit is configured to read the remanipulation rules from the mapping table.

3. The apparatus of claim 1, wherein the manipulated instruction comprises a manipulated operation code and the remanipulated instruction comprises an original operation code such that the manipulated operation code specifies a different operation than the original operation code,
and wherein the remanipulation unit is configured to replace the manipulated operation code by the original operation code.

4. The apparatus of claim 3, wherein the manipulated operation code comprises a binary number and the original operation code comprises a different binary number.

5. The apparatus of claim 1, wherein the manipulated instructions comprise a first instruction and a second instruction,
and wherein the remanipulation unit is configured to map the first instruction onto a third instruction and to map the second instruction onto a fourth instruction, and the third and fourth instructions comprise a same operation code.

6. The apparatus of claim 1, wherein the manipulated instruction comprises a sequence of a first instruction followed by a second instruction,
and wherein the remanipulation unit is configured to map the sequence of the first and second instruction onto a sequence of a fourth instruction followed by a fifth instruction.

7. The apparatus of claim 6, wherein the fourth instruction and the fifth instruction comprise a same operation code.

8. The apparatus of claim 1, wherein the manipulated instructions comprise a first instruction with a first operation code and a second instruction with a second operation code,
and wherein the remanipulation unit is configured to map the first operation code and the second operation code onto a third operation code.

9. The apparatus of claim 1, wherein the remanipulation rules comprise a dynamic remanipulation rule that changes during execution of the program, and wherein the remanipulation unit is configured to interpret the dynamic remanipulation rule.

10. The apparatus of claim 1, wherein the machine readable program comprises a stream of instructions comprising a first set of instructions and a second set of instructions, and wherein the remanipulation rules comprise a first set of remanipulation rules and a second set of remanipulation rules,
and wherein the remanipulation unit is configured to use the first set of remanipulation rules for the first set of instructions and to use the second set of remanipulation rules for the second set of instructions.

11. The apparatus of claim 1, wherein the remanipulation unit comprises an addition input device configured to input the remanipulation rules.

12. The apparatus of claim 1, further comprising an additional storage configured to store the remanipulation rules, and wherein the remanipulation unit is configured to read the remanipulation rules from the additional storage.

13. An apparatus to manipulate an instruction of a machine readable program according to manipulation rules, comprising:
a compiler configured to compile a machine readable program to be processed by a processor unit; and
a manipulation unit configured to manipulate an instruction such that the machine readable program comprises a stream of manipulated instructions,
wherein the processor unit is able to process the instructions and the remanipulated instruction.

14. The apparatus of claim 13, wherein the manipulation rules comprise a mapping table assigning an instruction to a manipulated instruction, and wherein the manipulation unit is configured to read the manipulation rules from the mapping table.

15. The apparatus of claim 13, wherein the manipulated instruction comprises a manipulated operation code and the instruction comprises an original operation code such that the manipulated operation code specifies a different operation than the original operation code,
and wherein the manipulation unit is configured to replace the original operation code by the manipulated operation code.

16. The apparatus of claim 13, wherein the instructions comprise a first instruction and a second instruction,
and wherein the manipulation unit is configured to map the first instruction onto a third instruction and to map the second instruction onto a fourth instruction, and the third and fourth instructions comprise a same manipulated operation code.

17. The apparatus of claim 13, wherein the instructions comprise a sequence of a first instruction followed by a second instruction, and wherein the manipulation unit is configured to map the sequence onto a further sequence of a fourth instruction followed by a fifth instruction.

18. The apparatus of claim 13, wherein the instructions comprise a first instruction and a second instruction, and the manipulation unit is configured to map both the operation code of the first instruction and the operation code of the second instruction onto a further operation code.

19. The apparatus of claim 13, wherein the manipulation rules comprises a dynamic manipulation rule, the dynamic manipulation rule changes during processing the program by the processor unit, and wherein the manipulation unit is configured to use the dynamic manipulation rule.

20. The apparatus of claim 13, wherein the manipulation unit comprises an addition input device configured to input the manipulation rules.

21. An apparatus for modifying instructions of a machine readable program according to remanipulation rules, comprising:
a first means for identifying a remanipulated instruction;
a second means for remanipulating the remanipulated instruction according to the remanipulation rule; and
a third means for processing a predetermined instruction set,
wherein the predetermined instruction set comprises manipulated instructions and remanipulated instructions.

22. A method for modifying instructions of a machine readable program according to remanipulation rules, said method comprising:
identifying a manipulated instruction;
remanipulating the manipulated instruction according to the remanipulation rules; and
processing the remanipulated instruction by a processor unit,
wherein the processor unit is able to process the manipulated and the remanipulated instruction.

23. A method for modifying instructions of a machine readable program according to manipulation rules, said method comprising:
compiling the machine readable program to be processed by a processor unit; and
manipulating an instruction of the machine readable program according to the remanipulation rules,
wherein the processor unit is able to process the instructions and the manipulated instruction.
